(19) United States
(12) Patent Application Publication
(10) Pub. No.: US 2026/0227317 A1
(43) Pub. Date: Aug. 6, 2026

(54) IMPROVEMENTS IN OR RELATING TO A FLOW DEVICE

(71) Applicant: REFEYN LTD, Oxford (GB)

(72) Inventors: Matthias LANGHORST, Oxford (GB); Lee PRIEST, Oxford (GB); David GRAHAM, Oxford (GB); Gogulan KARUNANITHY, Oxford (GB); Nathan CURRY, Oxford (GB)

(21) Appl. No.: 19/152,118

(22) PCT Filed: Jan. 31, 2024
(86) PCT No.: PCT/GB2024/050266

§ 371 Date: Jul. 30, 2025

(30) Foreign Application Priority Data
Jan. 31, 2023 (GB) 2301375.8

(51) Int. Cl. G01N 15/1434

(52) U.S. Cl. CPC G01N 15/1436

(57) ABSTRACT

A flow cell device comprising a fluid pathway having at least one wall and at least one solid immersion lens optically connected to the fluid pathway is provided. An apparatus and a method for measuring a property of an object are also provided.

The present invention relates to improvements in or relating to a flow cell device and in particular, to a device, apparatus and method for measuring a property of an object.

Interferometric scattering microscopy (referred to herein as ISCAT), has materialised as a powerful approach to both single particle tracking with unique spatiotemporal resolution and label-free sensitivity down to the single molecule level. ISCAT is disclosed, for example in Kukura et al., “High-speed nanoscopic tracking of the position and orientation of a single virus”, Nature Methods 2009 6:923-935, and in Ortega-Arroyo et al. “Interferometric scattering microscopy (ISCAT): new frontiers in ultrafast and ultra-sensitive optical microscopy”, Physical Chemistry Chemical Physics 2012 14:15625-15636. Despite considerable potential, widespread application of iSCAT has been limited by the requirement for custom-built microscopes, unconventional cameras and complex sample illumination, limiting the capabilities of iSCAT for the robust and accurate detection, imaging and characterisation of objects as small as single molecules.

One application of iSCAT is in Mass Photometry (MP), in which interferometric light scattering is used to quantify the mass and/or concentration of an object. Typically, MP measurements are taken at a measurement interface within an inverted microscope type geometry. This is accomplished by placing a small amount of the object onto the measurement interface. Challenges arise when combining MP with biochemical screening workflows in which large numbers of samples are prepared by robotic processes. Automation of the MP measurement process can be achieved by replicating each well onto a sample carrier by a robotic pipetting step, and then the sample carrier can interface with the iSCAT microscope. However, this approach has a limited throughput and introduces additional complexity to the overall workflow by requiring an additional robot. A major challenge when considering the cost efficiency of the combination of an automated MP process with biochemical screening, is the large number of sample carriers required to replicate the samples.

Therefore, there is a requirement to provide an efficient, automated process for measuring samples with an iSCAT microscope, which is compatible with current biochemical workflows, and which can achieve a cost efficiency and simplicity which enables it to be widely implemented. There is a requirement for the process to achieve a high sensitivity and resolution such that it is suitable for use in measurements at the single molecule level, and for use in taking measurements at an interface such as is required for mass photometry measurements.

In addition, a known method for constructing a solid immersion lens structure includes providing a mould defining a lens shaped cavity in which a solid immersion lens is cast, casting a translucent liquid elastomeric material into the lens cavity, permitting the elastomeric material to set to form the solid immersion lens portion and removing the solid immersion lens portion from the mould. Whilst this method provides an inexpensive and rapid construction of the solid immersion lens, the process can be complex and labour intensive. Furthermore, the moulding technique is not suitable for solid immersion lens made from materials having a high refractive index such as a variant glass SIL lens and/or a diamond SIL lens. In addition, the SIL made out of elastomeric materials are not able to withstand high laser intensity e.g. MegaWatts/cm² at the surface. Moreover, the SIL made out of elastomeric materials would not be able to provide a flat surface or a surface roughness on the nanometer scale, as the surface of the elastomeric solid immersion lens would be bowed.

It is against this background that the present invention has arisen.

According to an aspect of the present invention, there is provided a flow cell device comprising a fluid pathway having at least one wall and at least one solid immersion lens optically connected to the fluid pathway. The flow device as disclosed herein provides a simple device for measuring a property of an object in a fluid.

The flow cell device of the present invention provides an interface suitable for mass photometry measurements. The interface is provided by the solid immersion lens in contact with the fluid. The surface is therefore in contact with the fluid and any objects in the fluid, permitting objects to interact with or at the interface. Objects interacting with or near to the interface can be measured by optical techniques such as mass photometry.

According to an aspect of the present invention, there is provided a flow cell device comprising a fluid pathway having at least one wall and at least one solid immersion lens optically connected to the fluid pathway, wherein the solid immersion lens is made of a material with a refractive index that is substantially equal to or greater than the refractive index of glass.

Within the context of the present invention and unless otherwise specified, the term “high” or “higher” refers to any material(s) of the solid immersion lens is equal to or having a greater refractive index than a solid immersion lens made from glass. By way of example only, a diamond solid immersion lens has a higher refractive index than a glass solid immersion lens.

Within the context of the present invention and unless otherwise specified, the term “refractive index of glass” refers to the refractive index of standard glass in a medium. Variant forms of glass and/or high refractive index glass surfaces or materials are not considered as standard glass.

In some embodiments, the solid immersion lens can be a high refractive index glass material that is greater than the refractive index of glass.

A solid immersion lens made out of a material with a high refractive index can be advantageous as it enables high numerical apertures of the lens. A high numerical aperture is beneficial as it can increase the efficiency of collecting the scattered photons and result in an improved sensitivity of the measurement. Hence, providing a solid immersion lens made of a material with a high refractive index can help improve or enhance the resolution of an image detected by microscopy.

In some embodiments, there is provided a flow cell device comprising a fluid pathway having at least one wall and at least one solid immersion lens optically connected to the fluid pathway, wherein the solid immersion lens is made of a material with a refractive index that is substantially equal to or greater than the refractive index of fused silica. For example, the solid immersion lens can be made of material with a refractive index that is substantially equal to or greater than η=1.4.

According to an alternative aspect of the present invention, there is provided a flow cell device comprising a fluid pathway having at least one wall and at least one solid immersion lens optically connected to the fluid pathway, wherein the solid immersion lens is a diamond solid immersion lens. The flow device as disclosed herein provides a simple device for measuring a property of an object in a fluid.

Within the context of the present invention and unless otherwise specified, the term “optically connected” is used to describe where light is permitted to travel between the solid immersion lens and the fluid pathway. Alternatively described, the solid immersion lens is connected with the fluid pathway in an optical manner. In some examples, “optical connection” is achieved by the solid immersion lens being embedded into at least one wall of the fluid pathway. Alternatively, the solid immersion lens can be attached to at least one wall of the fluid pathway. There are various techniques that can be used to attach the solid immersion lens to the wall of the fluid pathway including but not limited to, gluing, pressing, cementing or bonding techniques.

Within the context of the present invention, the term ‘object’ as described herein, should be understood to include any suitable object such as but not limited to: a biomolecule, a protein, a peptide, a polypeptide, a lipoprotein, a glycoprotein, a lipid, a carbohydrate, an organic polymer, a protein complex, an antibody or an antibody fragment thereof, an enzyme or it may be a nucleic acid molecule such as DNA, RNA, a polysaccharide, or it may be a virus, or a viral vector such as an adenovirus and/or a lentivirus, a virus-like particle, or a small molecule, an exosome, a vesicle, an assembly complex, a nanoparticle, like lipid nanoparticles, liposomes or exosomes, a compound, an ion or a quantum dot. In some embodiments, the object may be a single molecule, a macromolecule or an association of molecules and macromolecules (such as polymers). Examples of suitable macromolecules may include, but are not limited to, nucleic acid molecules, either natural nucleic acids such as deoxyribonucleic acid (DNA) or ribonucleic acid (RNA), or artificial nucleic acids such as peptide nucleic acid (PNA), Morpholino and locked nucleic acid (LNA), as well as glycol nucleic acid (GNA) and threose nucleic acid (TNA). Associations of molecules can include assemblies such as virus-like particles where envelope or capsid proteins are associated.

In some embodiments, the object may be multi-molecular complexes comprising agglomerations of components, including proteins, such as monomer, dimer and trimer species, or other higher order agglomerations.

Within the context of the present invention, the term ‘biomolecule’ as described herein, should be understood to include a protein, a lipid, a carbohydrate, a lipoprotein, a glycoprotein, an organic polymer, a nucleic acid molecule, a virus, a vesicle, an assembly complex, or a virus-like particle.

As to be understood within the context of the present invention, a fluid pathway is configured to allow a passage of a fluid flowing through or along it and can be in any structural form known to the skilled person. The fluid pathway comprises at least one wall. The wall defines an inner area of the fluid pathway and acts as a barrier to prevent the leakage of the fluid from the fluid pathway during use. In some embodiments, the fluid pathway may comprise one circular wall configured to allow the passage of a fluid flowing through the fluid pathway. In some embodiments, the fluid pathway comprises four sidewalls configured to provide an enclosed fluid pathway containing the fluids within the fluid pathway. Other structural variations would be appreciated by the skilled person in the art.

The flow cell of the present invention includes the solid immersion lens (SIL) being optically connected to the fluid pathway. This reduces or eliminates any manufacturing variations between the different parts. In addition, the flow cell device of the disclosed invention can help reduce manufacturing costs. Furthermore, another advantage of the present invention is the reduction in noise/drift and usability issues that can arise from use of oil and standard objectives.

Moreover, the optical connection between the solid immersion lens and the at least one wall of the fluid pathway, can be used to measure a plurality of properties of the object in a fluid. For example, the light scattered from the object during illumination of the solid immersion lens can be detected to measure the mass of an object.

The solid immersion lens can be embedded in the wall of the fluid pathway. The solid immersion lens embedded in the wall of the fluid pathway forms a single unit that can help reduce manufacturing complexities and thus, reduces cost.

Any materials with a high refractive index can be suitable for the solid immersion lens. The solid immersion lens may be made of a material with a high refractive index. For example, the solid immersion may have a high refractive index glass surface. In particular, the solid immersion lens of the present invention can be made out of one or more materials with a refractive index that is substantially equal to or greater than glass.

TABLE 1
Example of refractive index of materials

| | Refractive |
|---|---|
| Material | Index (n) |
| Standard glass | 1.50 to 1.52 |
| Variant glass for example BK7 optical crown glass | 1.52 or above |
| High index glass | 1.53 to 1.75 |
| Diamond | 2.41 to 2.42 |
| Lithium niobate | 2.30 |
| Potassium Niobate | 2.28 |
| Sapphire | 1.76-1.78 |
| Cubic zircona | 2.15-2.18 |
| Fused silica | 1.4 to 1.55 |

In some embodiments, the solid immersion lens may be a diamond solid immersion lens. In some embodiments, a diamond solid immersion lens may be embedded into one wall of the fluid pathway. Providing a diamond solid immersion lens may be desirable as it has a high refractive index which enables high numerical apertures. In addition, the diamond solid immersion lenses are relatively robust which can be particularly advantageous for multiple uses. The refractive index (RI) of a diamond solid immersion lens is substantially η=2.42.

In some embodiments, the solid immersion lens may be made out of fused silica or any glass including high refractive index glass variants zirconia, sapphire, lithium niobate or potassium niobate. In some embodiments, the solid immersion lens may be made out a high refractive index glass material.

In some embodiments, the solid immersion lens may be made out of a material with a refractive index that is substantially greater than η=1.5 or η=1.52.

In some embodiments, the solid immersion lens may be hemispherical or superhemispherical. In some embodiments, the solid immersion lens may be a glass-half ball lens. In some embodiments, a superhemispherical solid immersion lens may be preferable. A superhemispherical solid immersion lens can increase the numerical aperture of the system by η² (with η refractive index of the solid immersion lens). A higher numerical aperture is beneficial as it can increase the collection of scattered photons and result in an improved sensitivity of the measurement.

In some embodiments, the solid immersion lens may have a diameter of 1 to 5 mm. In some embodiments, the solid immersion lens may have a diameter of more than 1.0, 1.5, 2.0, 2.5, 3.0, 3.5, 4.0 or 4.5 mm. In some embodiments, the solid immersion lens may have a diameter of less than 5.0, 4.5, 4.0, 3.5, 3.0, 2.5, 2.0 or 1.5 mm.

Additionally or alternatively, the solid immersion lens may have a length of 6 to 10 mm. In some embodiments, the solid immersion lens may have a length greater than 6.0, 6.5, 7.0, 7.5, 8.0, 8.5, 9.0 or 9.5 mm. In some embodiments, the solid immersion lens may have a length smaller than 10.0, 9.5, 9.0, 8.5, 8.0, 7.5, 7.0 or 6.5 mm.

In some embodiments, at least a part of a surface of the solid immersion lens has a surface roughness of less than 1 nm RMS. Root mean square (RMS) is a standard measurement of surface roughness known to the skilled person in the art.

In some embodiments, the surface roughness may be between 0.1 to 50 nm. For example, the surface roughness of the SIL may be more than 0.1, 1, 5, 10, 15, 20, 25, 30, 35, 40 or 45 nm RMS. Alternatively, the surface roughness of the SIL may be less than 50, 45, 40, 35, 30, 25, 20, 15, 10, 5 or 1 nm RMS.

In some embodiments, the surface roughness of the SIL may be between 0.1 to 1 nm RMS, or it can be more than 0.1, 0.2, 0.3 m 0.4, 0.5, 0.6, 0.7, 0.8 or 0.9 nm RMS. In some embodiments, at least a part of a surface of the solid immersion lens has a surface roughness of less than 1, 0.9, 0.8, 0.7, 0.6, 0.5, 0.4, 0.3 or 0.2 nm RMS. Preferably, the surface roughness of the solid immersion lens is 0.5 nm RMS.

The solid immersion lens (SIL) may comprise a flat surface for sample interface and a spherical surface. The solid immersion lens may have a minimum surface roughness of sub-nanometres RMS on the sample interface of the SIL. For iSCAT detection, this allows for accurate detection of small molecules, minimising the error on the detected signal, thus optimising mass resolution.

In some embodiments, the surface roughness may be less than 200 nm peak valley deviation on roundness on the spherical surface.

In some instances, the solid immersion lens may be polished such that the lobe on the spherical side is centered on the optical path. The deviations from the roundness of the spherical surface of the solid immersion lens can be corrected for in the use of free-form correction plate. The freeform correction plates and/or phase corrector plates can be used in optical systems to correct for wavefront deformations, such as spherical aberrations. In this context, a deviation from sphericity in the curved side of the SIL, through which the collected light passes, can cause a wavefront deformation and thus, this could be corrected for using a custom freeform correction plate.

In some instances where the solid immersion lens is made out of diamond, the solid immersion lens may be polished such that the lobe on the spherical side is centered on the optical path. Polishing the {100} crystal plane of the diamond SIL allows for two things. Firstly, it enables the best possible ultra fine surface roughness of the flat side or surface of the SIL. Secondly, it can centre the lobe on the spherical side or surface, which allows for a more radially uniform surface for much of the scattered light, in the high NA, to travel through. This may be advantageous as it can produce radially symmetric point spread functions, which in turn, maximises the contrast. Any polishing technique may be used.

In some embodiments, the flat surface of the SIL i.e. the sample interface may be polished for example, using ultra-fine mechanical polishing techniques, to remove grooves on the sample interface. The polishing procedure may smooth the surface of the SIL and advantageously reduces speckle effect.

The thickness and/or height of the solid immersion lens may have a tolerance of +/− sub 3 microns. The skilled person in the art would appreciate that the thickness and/or height the solid immersion may be adjusted or corrected for optimized performance in the optical system as disclosed herein.

In some embodiments, a coating may be provided on the surface of the solid immersion lens. In some embodiments, the coating may permit specific or enhanced binding of objects to the solid immersion lens. In some embodiments, the surface of the solid immersion lens may be coated with antibodies configured to bind to target biomolecules. This can be useful for detection assays. In some embodiments, the coating may enable transient binding at the surface of the solid immersion lens. For example, the coating may introduce an hydroxyl (OH) interaction with a protein that can be quantitatively broken by pH changes.

It will be appreciated that the coating may be applied at the interface between the solid immersion lens and the fluid. This coating may alter the interactions between the object and the solid immersion lens. The coating may decrease interactions or increase interactions. The interface between the fluid and the solid immersion lens may also be termed a “surface” of the solid immersion lens.

In some embodiments, the coating may passivate the surface of the solid immersion lens. This renders the surface of the solid immersion lens to become chemically inert. In some embodiments, the passivation of the surface of the solid immersion lens prevents the objects reacting and/or binding to the surface of the immersion lens.

In some embodiments, the coating may functionalise the surface of the solid immersion lens. In some embodiments, the coating provided on the surface of the solid immersion lens permits functionalisation such that particular objects are able to interact or bind to the solid immersion lens. For example, the coating may be (3-Aminopropyl)triethoxysilane (APTES), which gives the surface of the solid immersion lens a positive charge so that negatively charged biomolecules, such as DNA, can bind to the solid immersion lens.

The flow cell is made of any suitable material as disclosed above. The flow cell may be made of an entirely transparent material to radiation of selected wavelengths, such that optical measurements can be achieved at any desired location/region along the fluid pathway. Alternatively, the material used for the flow cell may be opaque (does not allow light to pass through). In such an embodiment, the flow cell may be provided with one or more windows to allow light to pass through. Such windows may be regions of transparent material.

In some embodiments, the fluid pathway may comprise one or more windows configured to enable optical measurements. Optical measurements through the window can take place at a different location to the solid immersion lens. In some embodiments, the one or more windows may be used for detecting radiation, such as emitted, reflected or scattered light, from the object. For example, fluorescence emitted from the object may be detected through one or more windows. In some embodiments, the one or more windows may facilitate obtaining additional information from the object. In some embodiments, a plurality of windows may be provided along the fluid pathway. This can be particularly useful for kinetics/time course experiments. In some embodiments, at least one window is provided on one fluid pathway. Light can enter through the window and into the fluid pathway of the flow cell. A reflective material, such as a mirror, can be provided within one the wall of the fluid pathway to enable light to be reflected through the same window and out of the flow cell device. In such an embodiment, a detector may be placed to detect the reflected light.

In some embodiments, at least two windows are provided on one fluid pathway to measure at least one property of the object over a defined path length. By way of example only, the first window can be provided on the first wall of the fluid pathway and a second window is provided on the second wall of the fluid pathway. In absorption measurements, a path length is defined as the distance between the two walls of the fluid pathway. Light enters through the first window and is then detected through the second window. In another example, where a circular wall is provided, a window is provided at a first location of at least one wall of the fluid pathway and a second window is provided on the same wall of the fluid pathway at a different location. The path length is defined by the distance between the first and second windows. Light can enter through the first window and is then detected through the second window.

An example of a property that may be measured through window(s) on the fluid pathway is absorption. From absorption measurements, the concentration of the object can be determined. In this example, a detector, such as a UV detector, can detect the light from the window for absorption measurements. From the absorption measurements, the concentration of the object can be determined. If more than one measurement is taken, concentration can be determined at various locations along the fluid pathway, to check for any variation.

Other properties may also be examined optically through any one or more windows, such as the ratio between objects in the fluid, for example the specific absorption of protein to nucleic acid ratio can be measured through the window. Additionally or alternatively, the fluorescence properties of the object can also be determined by measurements through the window.

Additionally or alternatively, at least a region of the fluid pathway may be transparent to radiation of selected wavelengths, which can be suitable for techniques such as absorption measurement. In use, light can enter into the flow cell through the transparent region of the fluid pathway. A reflective material can be provided within one wall of the fluid pathway that reflects the light out through the same transparent region of the fluid pathway for detection (such as absorption measurements). Further optical measurements can take place within the fluid pathway upstream from the solid immersion lens. Additionally or alternatively, optical measurements can take place within the fluid pathway downstream from the location of the solid immersion lens. This can be advantageous—for example during use, the concentration of the object may be affected as it flows through the flow cell device because the object may interact with the walls of the fluid pathway and/or with the passivated surface of the solid immersion lens. By performing absorption measurements both upstream and downstream from the solid immersion lens, the measurements can be used to check the concentration of the object in the fluid pathway. This can help determine if the concentration of the object has reduced due to interaction with the flow cell device (walls or lens).

In some embodiments, a plurality of fluid pathways are provided within the flow cell device. In some embodiments, each of the plurality of fluid pathways may comprise at least one solid immersion lens. In some embodiments, providing multiple fluid pathways may be advantageous as different conditions can be provided between each of the fluid pathways for optical measurements of the objects. In some embodiments, a plurality of solid immersion lenses may be provided within one fluid pathway.

In some embodiments, the solid immersion lens may be in contact with a fluid comprising an object.

According to another aspect of the present invention, there is provided an apparatus comprising
a flow cell according to a previous aspect of the invention;
an illumination source for illuminating a surface of the solid immersion lens; and
a first detector for capturing light through the solid immersion lens.

The apparatus may be an interferometric scattering microscope. In some embodiments, the apparatus may comprise a first detector configured to detect light from the object through the solid immersion lens. In some embodiments, the apparatus may comprise the first detector configured to detect the scattered light from the object on the surface of the solid immersion lens and/or the scattered light from the object in the fluid sample.

In some embodiments, the apparatus may further comprise a second detector configured to capture radiation transmitted through a window. In some embodiments, the apparatus may further comprise one or more additional detectors. In some embodiments, the apparatus may comprise a plurality of detectors. In some embodiments, by way of example only, the second detector may be used to detect the fluorescence emitted from the object and through the window or it may be used to detect and measure the absorbance.

In some embodiments, the second detector may be provided at or near the window to capture radiation transmitted through the window. In some embodiments, the second detector may be a UV detector configured to measure the absorption of the object through the window, which can then be used to determine the concentration of the object within the flow cell.

In some embodiments, the second detector and/or further detectors may be provided at the upstream end of the flow cell. As an example only, the second detector, which can be a UV detector, may be used to measure the absorbance of the object in a fluid before it enters the flow cell. This is advantageous because the measurements taken by the UV detector can be used to adjust or optimise specific parameters of other devices within the apparatus, such as a mixing device, in order to optimise the concentration measurements within the flow cell.

In some embodiments, the second detector may be configured to detect the fluorescence of the object in the fluid pathway through the window.

The apparatus may further comprise a mixing device. In some embodiments, the mixing device can be in any structural form that can perform the function of mixing or diluting the object. In its simplest form, the mixing device includes a sample inlet port configured to introduce a sample containing an object into the mixing device and a second inlet port configured to introduce a diluent or diluting agent fluid into the mixing device. Examples of a diluting agent can be water or buffer but the person skilled in the art would appreciate that other diluent fluids can be used. In some embodiments, the two inlet ports may be fluidically connected to a distribution channel or chamber where the two fluids enter and are mixed together.

Within the context of this invention, a sample includes an object. The sample can include the object in complex with another entity. The sample can be in a fluid flow.

In some embodiments, the apparatus may further comprise a liquid handling system. In some embodiments, the liquid handling system may select a specified volume of the object of interest for the flow cell device. In some embodiments, the liquid handling system may include one or more of the following: a pressure source such as syringe pumps with valves, mixers and/or air replacement pipettes. In some embodiments, the volume of sample selected may be between 1 to 10 μL.

In some embodiments the volume of sample selected may be more than 1, 2, 3, 4, 5, 6, 7, 8 or 9 μL. In some embodiments, the volume of sample selected may be less than 10, 9, 8, 7, 6, 5, 4, 3 or 2 μL. In some embodiments, the volume of sample selected may be between 1 to 100 μL. In some embodiments, the volume of sample selected may be more than 1, 10, 20, 30, 40, 50, 60, 70, 80 or 90 μL. In some embodiments, the volume of sample selected may be less than 100, 90, 80, 70, 60, 50, 40, 30, 20 or 10 μL.

In some embodiments, in use, the liquid handling system may be provided upstream of the flow cell device. The liquid handling system may select a specified volume of the sample for example, 1 to 10 μL. The pressure source, such as the syringe pump with valves, may be activated to move the selected sample into the flow cell for measurement. In some embodiments, the liquid handling system may be temperature controlled.

The liquid handling system may be used to automate the flow of the sample and of cleaning solutions into the flow cell device. By automating the cleaning step, the cleaning procedure can make use of aggressive solutions and/or more complex cleaning procedures without a risk to the user. This enables an appropriate cleaning solution to be selected which ensures the complete removal of the object from the solid immersion lens during the cleaning step, whilst preventing damage to the surface of the solid immersion lens. The cleaning step can therefore remove even “permanent” interactions between the object and the lens.

According to another aspect of the present invention, there is provided a method for measuring a property of an object, the method comprising:
providing a fluid comprising an object within a flow cell device according to any one of the aspects of the invention;
illuminating the surface of the solid immersion lens with an illumination source;
detecting the scattered, emitted or reflected light from the object through the solid immersion lens; and
measuring a property of the object using the detected light.

In some embodiments, the illuminating light may be spatially and temporally coherent. In some embodiments, the surface of the solid immersion lens may be illuminated with a laser light source. In some embodiments, a laser light source can achieve widefield illumination in the microscope by focusing of the collimated laser beam into the back focal plane of the imaging objective, implying that it can be efficiently coupled in and out of the microscope while minimally affecting the overall imaging performance.

Alternatively, the microscope may operate in a confocal mode, in which case the detector may be an image sensor or may be a point-like detector, such as a photo-diode, in which case a scanning arrangement may be used to scan a region of the object to build up an image. Examples of image sensors that may be employed as the detector include a CMOS (complementary metal-oxide semiconductor) image sensor or a CCD (charge-coupled device). The apparatus is further disclosed in WO2018/011591, the contents of which are hereby incorporated by reference.

A detector may be provided to detect the scattered, emitted or reflected light from the object through the solid immersion lens. In some embodiments, the detector may be part of a microscope set up. In particular, the detector may be part of an interferometric scattering microscope set up.

The interferometric microscope may further comprise at least one optical element configured to compensate for aberrations in the solid immersion lens. In some embodiments, solid immersion lenses with a small diameter can exhibit significant deviations from the optimal form. A solid immersion lens with a perfectly spherical surface will have a significant aberration, chromatic and coma off axis. In some embodiments, an optical element compensating for these aberrations can be integrated into the optical path. In some embodiments, the optical element can be a freeform element matching the solid immersion lens or a flexible element such as a high resolution spatial light modulator. In some embodiments, the optical element may include spherical lenses and/or a modified relay lens system. An optical system which can correct the deviations of the small diameter solid immersion lens is advantageous as it enables high resolution images to be captured.

In some embodiments, the optical element may include at least one aspheric lens. The aspheric lens is configured to manipulate or condition the light onto the solid immersion lens within the flow cell device. The aspheric lens can be used to reduce or eliminate spherical aberration and also reduce other optical aberrations and thus, it can improve the image quality. Alternatively or additionally, light can be provided directly onto the solid immersion lens.

In some embodiments, the interferometric scattering microscope may further comprise a spatial filter. In some embodiments, the iSCAT microscope may additionally be provided with a spatial filter, and can perform spatial filtering of output light, which comprises both light scattered from a sample location and illuminating light reflected from the sample location, prior to detection of the output light. The spatial filtering passes the reflected illumination light but with a reduction in intensity that is greater within a predetermined numerical aperture than at larger numerical apertures. This enhances the imaging contrast for coherent illumination, particularly for objects that are weak scatterers.

The spatial filter may be arranged to pass output light with a reduction in intensity within the predetermined numerical aperture to 10⁻² of the incident intensity or less. Typically, the spatial filter may be arranged to pass output light with a reduction in intensity within the predetermined numerical aperture to 10⁻⁴ of the incident intensity or more, for example in the range from 10⁻² to 10⁻⁴ of the incident intensity. Thus, in order to detect these weakly scattering objects a particular aperture may be used.

The spatial filter selectively reduces the intensity of the illuminating light over scattered light, by taking advantage of the mismatch between the numerical aperture of reflected illuminating light and of light scattered from objects in a sample at the sample location.

Thus, the spatial filter takes advantage of the different directionalities of these two sources of light. The reflected illuminating light will typically have a relatively small numerical aperture, whereas sub-diffraction-sized objects near a surface of the sample scatter light preferentially into high numerical apertures. Therefore, the reduction in intensity by the spatial filter at low numerical apertures predominantly affects the illuminating light and has a minimal effect on the scattered light, thereby maximising the imaging contrast.

This effect may be maximised by arranging the spatial filter so that the predetermined numerical aperture is identical or similar to the numerical aperture of the illuminating light reflected from the sample location.

In some embodiments, the step of measuring a property of the object may include quantifying the mass of the object. In some embodiments, the step of measuring a property of the object may include measuring or quantifying a change in the mass of an object. In some embodiments, the method of the present invention may be used to carry out mass photometry, wherein the mass of the object is quantified by interferometric light scattering. In some embodiments, the mass can be quantified with up to 5% mass error.

In some embodiments, the method may further comprise the step of detecting the scattered light from the object in solution, wherein the object has a diameter that is greater than 10 nm. In some embodiments, the object with a diameter greater than 10 nm can be detected whilst in solution within the fluid pathway. In some embodiments, upon illumination of the solid immersion lens by the illumination source, the measurement of the scattered light can be utilised to determine at least one property of the object in solution. This can be advantageous as the object does not interact with the surface of the solid immersion lens and therefore, there is no requirement for removing the object from the solid immersion lens and cleaning after use. Thus, the flow cell can be easily reusable for further optical measurements.

In some embodiments, the object may have a diameter greater than 20 nm. Objects having a diameter of greater than 10 nm, 15 nm or 20 nm can be detected within the fluid flowing along the fluid pathway. This means that there is no requirement for the object to interact with the surface of the solid immersion lens and hence, no cleaning step will be necessary.

In some embodiments, the object may interact with the surface of the solid immersion lens. In some embodiments, the interaction between the object and the surface of the lens may involve the object adsorbing to the surface of the solid immersion lens. In some embodiments, the interaction between the object and the surface of the solid immersion lens may be electrostatic binding interaction, and/or the binding may be formed via by salt bridges. In some embodiments, the interaction may involve hydrophobic interactions between the object and the surface of the solid immersion lens. Further, the interaction may be specific i.e., the surface can be coated with binding entities such as antibodies or aptamers.

In some embodiments, the interaction of the object and the solid immersion lens takes place at the interface, i.e., the surface of the solid immersion lens in contact with the fluid. This interface receives light from a light source and permits detection of objects interacting with the solid immersion lens, and therefore the interface provides the surface that are usually required in light scattering microscopy, whilst also functioning as a lens.

The use of a solid immersion lens interacting directly with the object, enables both a high sensitivity and a high refractive index (RI) at the measurement interface to be achieved. The higher numerical aperture of the solid immersion lens compared to conventional lenses facilitates the collection of a larger number of scattered photons, therefore increasing the sensitivity of the method. Additionally, the high refractive index of the solid immersion lens means the method of the present invention is compatible with a wider range of solvents compared to a conventional iSCAT microscope. The high refractive index of the solid immersion lens enables a sufficient refractive index difference to be achieved with even high refractive index solvents. For example, the method of the present invention can be used to measure organic polymers, which tend to be only soluble in solvents of RI 1.4 or higher.

Typically, the object directly interacts with the surface of the solid immersion lens. The object may be provided in a solution, or in a fluid, for example as a suspension. In some instances, the charge on the surface of the solid immersion lens may be altered in such a way that it allows for interactions such as hydroxyl (OH) or ionic interactions to occur between the object and the solid immersion lens.

In some embodiments, the interaction between the object and the surface of the solid immersion lens can be indirect. Indirect interactions may occur where a silane coating is provided on the surface of the solid immersion lens. In this case, the object can only interact with the silane coating rather than directly on the surface of the solid immersion lens.

In some embodiments, the method may further comprise the step of detecting the scattered light from the object on the surface of the solid immersion lens.

Thus, the scattered light may be detected from the interface between the solid immersion lens and the fluid.

In some embodiments, the method may further comprise the step of coating the surface of the solid immersion lens. In some embodiments, the coating of the surface of the immersion lens may aid the interaction between the object and the surface of the lens. For example, the object may adsorb onto the surface of the solid immersion lens. In this case, a subsequent cleaning step is required to remove the object from the surface of the solid immersion lens.

Alternatively, the coating of the solid immersion lens may prevent objects interacting with the surface of the solid immersion lens. If the surface of the solid immersion lens is passivated, this prevents the interactions of the object with the coating of the solid immersion lens. There is no requirement for a subsequent cleaning step. One or more object can be measured in solution along the fluid pathway of the device.

In some embodiments, the method may further comprise the step of cleaning the solid immersion lens. In some embodiments, the method of the present invention also facilitates the controlled cleaning of the solid immersion lens such that it can be re-used in subsequent measurements.

In some embodiments, the method may further comprise the step of cleaning the solid immersion lens such that the object is removed from the surface of the solid immersion lens. In some embodiments, the cleaning process is carried out without user interaction, which enables the cleaning process to be optimised to ensure the entirety of the object is removed from the surface of the solid immersion lens, without damage to the lens or risk to the user.

By enabling effective cleaning of the solid immersion lens, the method can prevent the requirement for a disposable solid immersion lens and ensures compatibility with high throughput biochemical screening workflows.

In some embodiments, a coating may be provided to aid the interaction between the object and the surface of the solid immersion lens. A cleaning step is then applied to remove the object and the coating from the surface of the solid immersion lens. After the cleaning step, a different coating can be applied to passivate the surface of the solid immersion lens so that it prevents objects interacting with the surface of the solid immersion lens.

In some embodiments, the cleaning of the solid immersion lens may include flowing at least one cleaning solution through the fluid pathway. In some embodiments, an appropriate cleaning solution can be selected which ensures the complete removal of the object from the solid immersion lens during the cleaning step, whilst preventing damage to the surface of the solid immersion lens. In some embodiments, the cleaning of the solid immersion lens may include flowing successive cleaning solutions through the fluid pathway. In some embodiments, the cleaning fluid may include, but is not limited to, ethanol, isopropanol or similar alcohols, and/or water.

In some embodiments, the cleaning of the solid immersion lens may include flowing at least one more aggressive cleaning solution through the fluid pathway, depending on the object adsorbed on the surface, or interacting with the surface of the solid immersion lens. In some embodiments, the cleaning of the solid immersion lens may include flowing an acid such as hydrochloric acid and/or sulphuric acid through the fluid pathway, followed by a flow of water. In some embodiments, flowing an oxidating acid such as sulphuric acid over the solid immersion lens, may also functionalise the surface. Additionally or alternatively, the step may include flowing a base, such as sodium hydroxide to functionalise and/or cleaning the surface.

In some embodiments, the method may further comprise the step of agitating the cleaning solution. In some embodiments, the step of agitating the cleaning solution may include the use of a sonicator bath to facilitate the removal of the object from the surface of the solid immersion lens. In some embodiments, the sonicator bath may be temperature controllable to facilitate the agitation of cleaning solution at the temperature best suited to the remove the object from the solid immersion lens.

In some embodiments, the method may further comprise the step of flowing air over the solid immersion lens. In some embodiments, the solid immersion lens may be air-dried following the cleaning step. This prevents any cleaning solution on the solid immersion lens from contaminating the sample solution in subsequent measurements.

In some embodiments, the method may further comprise the step of applying a plasma to the surface of the solid immersion lens. In some embodiments, plasma can be applied to the surface of the solid immersion lens for example with an environmental pressure plasma torch. In some embodiments, plasma can be applied to the surface of the solid immersion lens as part of the cleaning process to remove the object adsorbed to the surface of the lens.

The invention will now be described, by way of example only, with reference to the accompanying drawings in which:

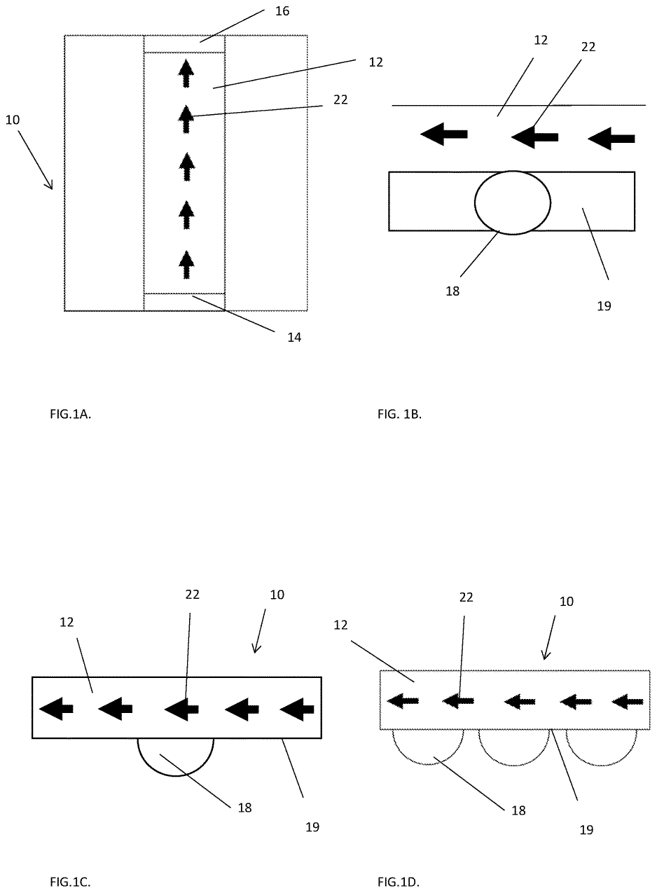

FIG. 1A shows a flow cell device according to the present invention;

FIG. 1B shows a solid immersion lens embedded into at least wall of the fluid pathway;

FIG. 1C shows a cross-section view of the flow cell device of FIG. 1A having one solid immersion lens;

FIG. 1D shows a cross-sectional view of the flow cell device of FIG. 1A having a plurality of solid immersion lens;

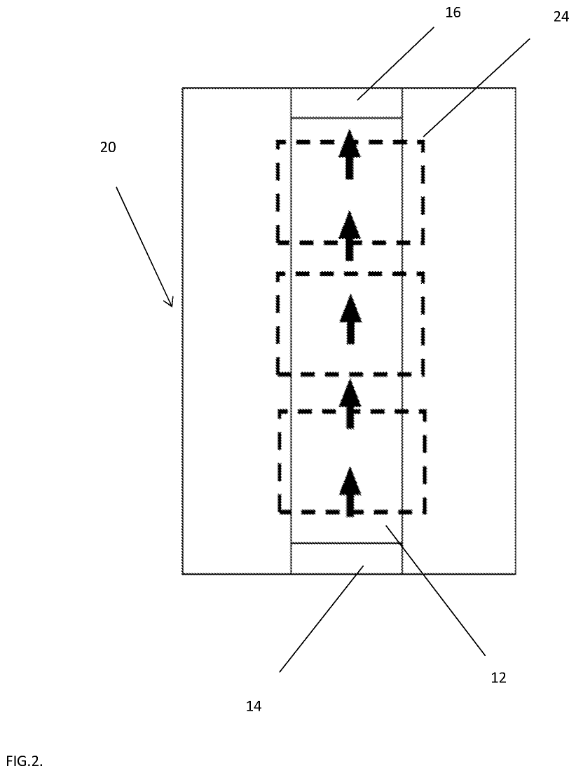

FIG. 2 shows a flow cell device further comprising windows;

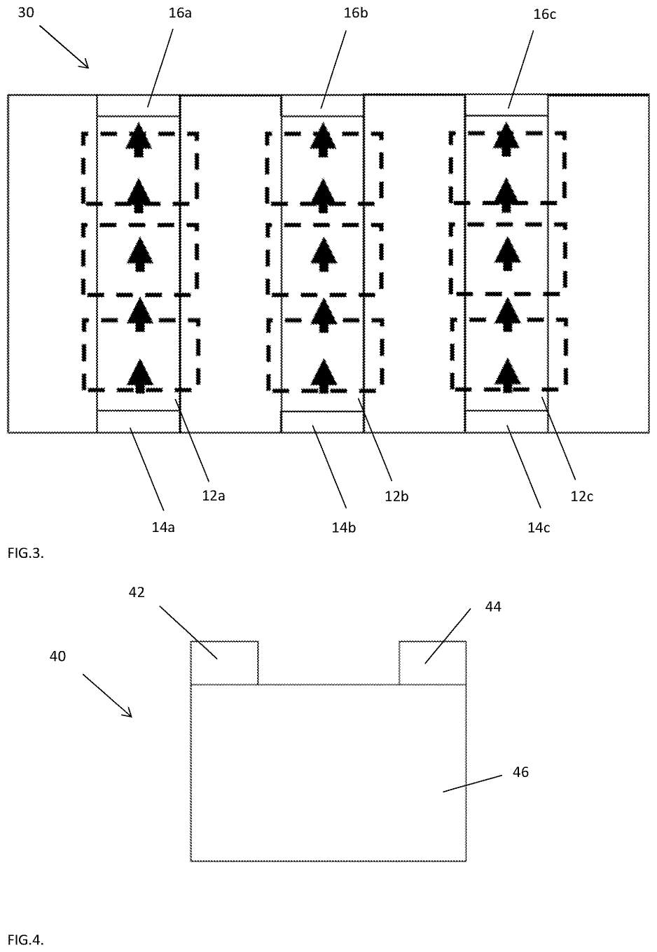

FIG. 3 shows a flow cell device comprising a plurality of flow pathways;

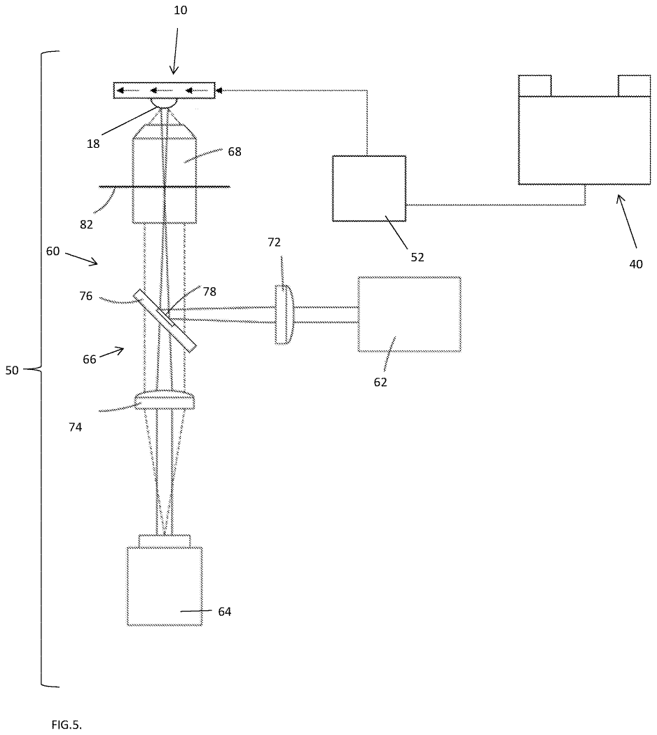

FIG. 4 shows a fluid mixing device; and

FIG. 5 shows an apparatus for measuring a property of an object within a flow cell device.

According to the present invention there is provided a flow cell device, an apparatus and a method for measuring a property of an object in a fluid within the flow cell device.

Referring to FIG. 1A, there is provided a flow cell device 10 comprising a fluid pathway 12 with an inlet 14 and an outlet 16. The fluid pathway 12 of the flow cell device 10 has at least one wall 19 and at least one solid immersion lens 18 optically connected to the fluid pathway 12. The at least one solid immersion lens 18 can be embedded into the wall 19 of the fluid pathway 12, as shown in FIG. 1B. The flow cell device 10 may comprise one solid immersion lens 18, as shown in FIG. 1C. Alternatively, the flow cell device 10 may comprise more than one solid immersion lens 18, as shown in FIG. 1D. By way of example only, FIG. 1B shows wall 19 of the fluid pathway 12 comprising three solid immersion lenses. The solid immersion lens 18 may be a diamond solid immersion lens or may be made of fused silica or any glass including high refractive index glass variants zirconia, sapphire or lithium niobate. The solid immersion lens 18 may be hemispherical, superhemispherical or may be a glass-half ball lens. The solid immersion lens 18 may have a diameter of 1 to 5 mm and may have a length of 6 to 10 mm.

The flow cell device 10 can be used to measure a property of the object in fluid within the fluid pathway 12. Fluid comprising the object is introduced into the flow cell device 10 via the inlet 14, and flows along the fluid pathway 12, in the direction of the arrows 22 to the outlet 16. The one or more solid immersion lenses 18 are illuminated, and the object within the fluid pathway 12 scatters the light which can be subsequently detected. The detected scattered light from the object can be used to measure at least one property of the object. The detected scattered light can be used to measure the mass of the object, for example.

The solid immersion lens 18 may be provided with a coating to permit specific or enhanced binding of objects to the solid immersion lens 18 within the fluid pathway 12. The solid immersion lens 18 can be coated with antibodies configured to bind to target biomolecules. The coating may enable transient binding at the surface of the solid immersion lens 18. For example, the coating may introduce a hydroxyl (OH) interaction with a protein that can be quantitatively broken by pH changes. The coating may passivate the surface of the solid immersion lens 18 such that the surface of the solid immersion lens 18 becomes chemically inert. Passivation of the surface of the solid immersion lens 18 can prevent objects reacting and/or binding to the surface of the solid immersion lens 18. The coating may functionalise the surface of the solid immersion lens 18. The coating may enable particular objects to interact or bind to the solid immersion lens 18. For example, the coating can be 3-(aminopropyl)triethoxysilane (APTES), which gives the surface of the solid immersion lens 18 a positive charge so that negatively charged biomolecules, such as DNA, can bind to the solid immersion lens 18.

Referring to FIG. 2, at least part of the fluid pathway 12 may be transparent to radiation of selected wavelengths. The fluid pathway 12 may comprise one or more windows 24 configured to enable optical measurements. By way of example only, the flow cell device 20 shown in FIG. 2 comprises three windows 24. The windows 24 facilitate the taking of additional measurements from an object within the fluid pathway 12. The windows 24 can be used for detecting radiation from the object. For example, fluorescence emitted from the object may be detected through one or more windows 24. When at least two windows 24 are provided along one fluid pathway 12, a property of the object can be measured over a defined path length, which can be useful for taking absorption measurements and determining the concentration of the object. This can help determine the presence of aggregation, such as protein aggregation. The one or more windows 24 may also permit the ratio between objects in the fluid, for example the specific absorption of protein to nucleic acid ratio to be measured.

The object may be a biomolecule, a protein, a peptide, a polypeptide, a lipoprotein, a glycoprotein, a lipid, a carbohydrate, an organic polymer, a protein complex, an antibody or an antibody fragment thereof, an enzyme or it may be a nucleic acid molecule such as DNA, RNA, a polysaccharide, or it may be a virus, or a viral vector such as an adenovirus and/or a lentivirus, a virus-like particle, or a small molecule, an exosome, a vesicle, an assembly complex, a nanoparticle, a compound, an ion or a quantum dot. The object may be a single molecule, a macromolecule, or an association of molecules and macromolecules (such as polymers). Examples of suitable macromolecules include, but are not limited to, nucleic acid molecules, either natural nucleic acids such as deoxyribonucleic acid (DNA) or ribonucleic acid (RNA), or artificial nucleic acids such as peptide nucleic acid (PNA), Morpholino and locked nucleic acid (LNA), as well as glycol nucleic acid (GNA) and threose nucleic acid (TNA). Associations of molecules can include assemblies such as virus-like particles where envelope or capsid proteins are associated.

The object may be multi-molecular complexes comprising agglomerations of components, including proteins, such as monomer, dimer and trimer species, or other higher order agglomerations.

Referring to FIG. 3, the flow cell device 30 comprises a plurality of fluid pathways 12a, 12b, 12c. Each of the fluid pathways 12a, 12b, 12c comprises an inlet 14a, 14b, 14c and an outlet 16a, 16b, 16c. Each of the fluid pathways 12a, 12b, 12c may comprise a solid immersion lens 18 optically connected to the fluid pathways 12a, 12b, 12c. Each of the fluid pathways 12a, 12b, 12c may be provided with different conditions or parameters for taking optical measurements.

Referring to FIG. 4, a mixing device 40 is shown for mixing a fluid prior to its input into the flow cell device 10, 20 or 30 via the inlet port 14. FIG. 4 shows the mixing device in its simplest form, although the mixing device 40 may take any structural form. The mixing device 40 comprises a sample inlet port 42 configured to introduce a sample containing an object into the mixing device 40, and a second inlet port 44 configured to introduce a diluent or diluting agent fluid into the mixing device 40. Examples of a diluting agent can be water or buffer but the skilled person would appreciate that other diluent fluids can be used. The two inlet ports 42, 44 are fluidically connected to a distribution channel or chamber 46, where the two fluids enter and are mixed together.

Referring to FIG. 5, the mixing device 40 and the flow cell device 10 form part of an apparatus 50 for measuring a property of an object. The apparatus 50 may be used to quantify the mass of the object and/or to measure or quantify a change in the mass of an object. Although the flow cell device 10 is shown in FIG. 5, it should be understood that any of the flow cell device embodiments 10, 20 or 30 described herein, can form part of the apparatus 50.

The apparatus 50 may be an interferometric scattering microscope 60 as shown in FIG. 5. The apparatus 50 comprises an illumination source 62, arranged to provide illuminating light to a surface of the solid immersion lens 18 of the flow cell device 10. The illuminating light may be spatially and temporally coherent. The illumination source 62 may be a laser light source. The wavelength of the illuminating light may be selected in dependence on the nature of the sample and/or the properties to be examined. In one example, the illuminating light has a wavelength of 405 nm.

Optionally, the illumination light may be modulated spatially, to remove speckle patterns that arise from the coherent nature of the illumination and laser noise, for example as detailed in Kukura et al., “High-speed nanoscopic tracking of the position and orientation of a single virus”, Nature Methods 2009 6:923-935.

The apparatus 50 comprises a detector 64 configured to receive output light scattered, emitted or reflected from the object in the fluid sample in the flow cell 10 through the solid immersion lens 18. Alternatively or additionally, the detector 64 may detect light scattered by the object in the flow cell device 10 on the surface of the solid immersion lens 18.

Typically, the microscope 60 may operate in a wide-field mode, in which case the detector 64 may be an image sensor that captures an image of the object. The microscope 60 may alternatively operate in a confocal mode, in which case the detector 64 may be an image sensor or may be a point-like detector, such as a photo-diode, in which case a scanning arrangement may be used to scan a region of the object to build up an image. Examples of image sensors that may be employed as the detector 64 include a CMOS (complementary metal-oxide semiconductor) image sensor or a CCD (charge-coupled device).

The microscope 60 further comprises an optical system 66 arranged between the flow cell device 10, the illumination source 62 and the detector 64. The optical system 62 is arranged as follows to direct illuminating light onto the solid immersion lens 18 for illuminating the object, and to collect output light from the object and to direct the output light to the detector 64.

The optical system 66 includes an objective lens 68, a condenser lens 72 and a tube lens 74. The condenser lens 72 condenses illuminating light from the light source 62 (shown by continuous lines in FIG. 5) through the objective lens 68 onto the solid immersion lens 18 of the flow cell device 10. The objective lens 68 collects the output light which comprises both (a) illuminating light reflected from the object location (shown by continuous lines in FIG. 5), and (b) light scattered from the object (shown by dotted lines in FIG. 5). The reflected light is predominantly reflected from the interface between the solid immersion lens 18 and the object. Typically, this is a relatively weak reflection, for example a glass-water reflection. For example, the intensity of the reflected illuminating light may be of the order of 0.5% of the intensity of the incident illuminating light.

In a similar manner to conventional iSCAT, scattered light from objects at or close to the surface of the sample constructively interfere with the reflected light and so are visible in the image captured by the detector 64. This effect differs from a microscope operating in transmission wherein the illuminating light that reaches the detector is transmitted through the depth of the sample leading to a much smaller imaging contrast.

As shown in FIG. 5, the reflected illuminating light and the scattered light have different directionalities. In particular, the reflected illuminating light has a numerical aperture resulting from the geometry of the beam of light output by the light source 62 and the optical system 66. The scattered light is scattered over a large range of angles and so fills larger numerical aperture than the reflected illuminating light. The tube lens 74 focuses the output light from the objective lens 68 onto the detector 64.

The optical system 74 also includes a beam splitter 76 that is arranged to split the optical paths for the illuminating light from the light source 62 and the output light directed to the detector 64. Except for the provision of a spatial filter as described below, the beam splitter 74 may have a conventional construction that provides partial reflection and partial transmission of light incident thereon. For example, the beam splitter 74 may be a plate, typically provided with a film, which may be metallic or dielectric, arranged at 45° to the optical paths.

Alternatively, the beam splitter 74 may be a cube beam splitter formed by a matched pair of prisms having a partially reflective film at the interface between the prisms. Alternatively, the beam splitter 74 may be a polarising beam splitter, used in combination with a quarter wave plate between the beam splitter 74 and the flow cell device 10.

In the example shown in FIG. 5, the light source 62 is offset from the optical path of the objective lens 68 so that the illuminating light from the light source 62 is reflected by the beam splitter 74 into the objective lens 68, and conversely the detector 64 is aligned with the optical path of the objective lens 68 so that the output light from the flow cell device 10 is transmitted through the beam splitter 74 towards the detector 64.

In addition to the components described above that may be of a conventional construction, the microscope 60 includes a spatial filter 78. In the example shown in FIG. 5, the spatial filter 78 is formed on the beam splitter 74 and is thereby positioned behind the back aperture of the objective lens 68, and so directly behind the back focal plane 82 of the objective lens 68. Thus, the spatial filter 78 may be implemented without entering the objective lens 68 as in phase contrast microscopy. Placing the spatial filter directly behind the entrance aperture of the objective rather than in a conjugate plane (for example as described below) has the distinct advantage of strongly suppressing back reflections originating from the numerous lenses within high numerical aperture microscope objectives. This, in turn, reduces imaging noise, lowers non-interferometric background and reduces the experimental complexity, number of optics and optical path length leading to increased stability of the optical setup and thus image quality.

However this location is not essential and a spatial filter having an equivalent function may be provided elsewhere as described below. The spatial filter 78 is thereby positioned to filter the output light passing to the detector 64. In the example shown in FIG. 5 in which the detector 64 is aligned with the optical path of the objective lens 68, the spatial filter 78 is therefore transmissive.

The spatial filter 78 is partially transmissive and therefore passes the output light, which includes the reflected illumination light, but with a reduction in intensity. The spatial filter 78 is also aligned with the optical axis and has a predetermined aperture so that it provides a reduction in intensity within a predetermined numerical aperture. Herein, numerical aperture is defined in its normal manner as being a dimensionless quantity characterising a range of angles with respect to the sample location from which the output light originates. Specifically, the numerical aperture NA may be defined by the equation NA=n·sin (θ), where θ is the half angle of collection and n is the refractive index of the material through which the output light passes (for example the material of the components of the optical system 66).

A fluid comprising an object is provided within the flow cell device 10, the surface of the solid immersion lens 18 is illuminated via the illumination source 62 and the scattered, emitted or reflected light from the object through the solid immersion lens 18 is detected by the detector 64 which uses the detected light to measure a property of the object.

The object may interact with the surface of the solid immersion lens 18 via one or more of: adsorption of the object onto the surface of the solid immersion lens 18, electrostatic binding interaction, binding via by salt bridges, hydrophobic interactions between the object and the surface of the solid immersion lens 18.

Interaction between the solid immersion lens 18 and the object may be direct or indirect. Direct interaction may occur if the charge on the surface of the solid immersion lens 18 is altered in such a way that it allows for hydroxyl (OH) or ionic interactions to occur between the object and the solid immersion lens 18.

Indirect interaction between the object and the surface of the solid immersion lens 18 may occur where a silane coating is provided on the surface of the solid immersion lens and the object interacts with the silane coating rather than directly on the surface of the solid immersion lens 18.

Indirect interaction may also occur between the object and the surface of the solid immersion lens in some situations where the coating functionalises the surface of the solid immersion lens.

The detector 64 may detect the scattered light from the object on the surface of the solid immersion lens 18. The surface of the solid immersion lens 18 may be cleaned after use such that the object is removed from the solid immersion lens 18, and the flow cell device 10 can be re-used in subsequent measurements. Cleaning fluid may be flowed through the fluid pathway 12 of the flow cell device 10, requiring minimal user interaction to clean the flow cell device 10 for re-use. The cleaning solution may be agitated via a sonicator bath, for example, to facilitate the removal of the object from the surface of the solid immersion lens 18. Subsequently, air may be flowed over the solid immersion lens 18 to dry the solid immersion lens 18 and prevent any cleaning solution on the solid immersion lens 18 from contaminating subsequent measurements. Alternatively or additionally, the surface of the solid immersion lens 18 may be exposed to plasma with an environmental pressure plasma torch, for example.

Where the object has a diameter greater than 10 nm, the apparatus 50 may be used to measure a property of the object in solution within the flow pathway 12 of the flow cell device 10 without the object interacting with the surface of the solid immersion lens 18. The detector 64 may be configured such that the apparatus 50 can be used for detecting the scattered light from the object whilst in solution within the fluid pathway 12. The apparatus can be used to detect the scattered light from the object in solution via the detector 64 and to determine at least one property of the object in solution. As the object does not interact with the surface of the solid immersion lens 18, there is no requirement for removing the object from the solid immersion lens 18 and cleaning after use.

In some embodiments, the object may have a diameter that is greater than 10, 20, 50, 100, 150, 200, 250, 300, 350, 400, 500, 600, 700, 800, 900 or 1000 nm. The object may be in the range of 10 to 1000 nm, 10 to 900 nm, 10 to 800 nm, 10 to 700 nm, 10 to 600 nm, 10 to 500 nm, 10 to 400 nm, 10 to 300 nm, 10 to 200 nm, 10 to 100 nm or 10 to 50 nm.

When the apparatus 50 comprises a flow cell device 20 or 30, as shown in FIGS. 2 and 3, comprising one or more windows 24, the apparatus 50 may further comprise additional detectors (not shown in the accompanying drawings). The additional detectors may be configured to capture radiation transmitted through the one or more windows 24. The one or more additional detectors may be used to detect the fluorescence emitted from the object and through the window 24, or they may be used to detect and measure the absorbance. One or more of the additional detectors may be a UV detector.

Alternatively or additionally, one or more additional detectors may be provided at the upstream end of the flow cell. If one or more of the upstream additional detectors is a UV detector, it may be used to measure the absorbance of the object in a fluid before it enters the flow cell device 10. These measurements can be used to adjust or optimise specific parameters of other devices within the apparatus, such as the mixing device 40, in order to optimise the concentration measurements within the flow cell 10. Additional detectors may also be provided downstream of the flow cell for further measurements.

The apparatus 50 may comprise a liquid handling system 52 configured to select a specified volume of the sample of interest or cleaning solution for the flow cell device 10. As shown in FIG. 5, the liquid handling device 52 can be provided upstream of the flow cell device 10. The liquid handling system 52 may include one or more of the following: a pressure source such as syringe pumps with valves, mixers and/or air replacement pipettes. The pressure source, such as the syringe pump with valves, may be activated to move the selected sample into the flow cell device 10 for measurement. The liquid handling system 52 may select between 1 to 10 μL of sample. Alternatively or additionally, the liquid handling system 52 may select 1 to 100 μL of sample.

### EXAMPLES

### Materials and Methods

### Optical

Operating wavelength range can be between 515-535 nm. Chromatic aberration may limit the wavelength range for specified performance without refocusing to (0.2/5) nm. A good imaging performance can be defined as: Field of view (15 μm/30 μm) diameter centred on the optic axis. NA (1.8/2.1) for diamond (1.6/1.8) for high index glass or cubic zirconia. Diffraction limited imaging over the field of view, Strell ratio> (0.9/0.95).

### Other Optical Properties

To reach the above NA in the solid immersion lens the NA of the aspheric can be around 0.35. Diameter of 4 mm can be provided to fit in tip. Anti-reflective coatings can be applied onto the aspheric and/or relay lenses, R<1%. Low stray light and avoiding reflections sent back along the imaging path. Effective focal length of solid immersion lens-aspheric system, to determine magnification, 0.5 to 5 mm. Note the n² magnification of the solid immersion lens. Low stress birefringence as polarisation can be important.

Laser damage threshold can be provided high enough to allow a 2 W beam occupying any 10% of the area of the aspheric lens clear aperture. Additionally or alternatively, the solid immersion lens can be made by Asphericon surface roughness of flat surface (2, <1) 15 nm RMS.

### Mechanical

The system can be built with a solid immersion lens having a 5 mm maximum diameter for a maximum length of 10 mm. The solid immersion lens and aspheric lens should be securely mounted in positions to achieve the above optical performance. Thermal expansion of components should not prevent focusing over a temperature range of 20 to 22, 15 to 40 Celsius.

Various further aspects and embodiments of the present invention will be apparent to those skilled in the art in view of the present disclosure.

“and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

Unless context dictates otherwise, the descriptions and definitions of the features set out above are not limited to any particular aspect or embodiment of the invention and apply equally to all aspects and embodiments which are described.

It will further be appreciated by those skilled in the art that although the invention has been described by way of example with reference to several embodiments. It is not limited to the disclosed embodiments and that alternative embodiments could be constructed without departing from the scope of the invention as defined in the appended claims.

1. A flow cell device comprising a fluid pathway having at least one wall and at least one solid immersion lens optically connected to the fluid pathway, wherein the solid immersion lens is made of a material with a refractive index that is substantially equal to or greater than the refractive index of glass.

2. The flow cell device according to claim 1, wherein the solid immersion lens is embedded in the wall of the fluid pathway.

3. The flow cell device according to any one of the preceding claims, wherein the solid immersion lens is made out of one of the following; diamond, zirconia, sapphire, lithium niobate or potassium niobate.

4. The flow cell device according to any one of the preceding claims, wherein the solid immersion lens is made out of high refractive index glass.

5. The flow cell device according to any one of the preceding claims, wherein the solid immersion lens is made of a material with a refractive index that is greater than η=1.5.

6. The flow cell device according to any one of the preceding claims, wherein the solid immersion lens is a diamond solid immersion lens.

7. The flow cell device according to any one of the preceding claims, wherein a surface of the solid immersion lens has a surface roughness of less than 1 nm RMS.

8. The flow cell device according to any one of the preceding claims, wherein a coating is provided on the surface of the immersion lens.

9. The flow cell device according to claim 8, wherein the coating passivates the surface of the solid immersion lens.

10. The flow cell device according to claim 8, wherein the coating functionalises the surface of the solid immersion lens.

11. The flow cell device according to any one of the preceding claims, wherein the fluid pathway comprises one or more windows configured to enable optical measurements.

12. The flow cell device according to any one of the preceding claims, wherein the solid immersion lens is in contact with a fluid comprising an object.

13. An apparatus comprising
a flow cell according to any one of the preceding claims;
an illumination source for illuminating a surface of the solid immersion lens; and
a first detector for capturing light through the solid immersion lens.

14. The apparatus according to claim 13, wherein the apparatus is an interferometric scattering microscope.

15. The apparatus according to any one of claims 13 to 14, further comprising a second detector configured to capture radiation transmitted through the window.

16. The apparatus according to any one of claims 13 to 15, further comprising a mixing device.

17. The apparatus according to any one of claims 13 to 16, further comprises a liquid handling system.

18. A method for measuring a property of an object, the method comprising:
providing a fluid comprising an object within a flow cell device according to any one of claims 1 to 12;
illuminating the surface of the solid immersion lens with an illumination source;
detecting the scattered, emitted or reflected light from the object through the solid immersion lens; and
measuring a property of the object using the detected light.

19. The method according to claim 18, further comprising the step of detecting the scattered light from the object in solution, wherein the object has a diameter that is greater than 10 nm.

20. The method according to claim 18, wherein the object interacts with the surface of the solid immersion lens.

21. The method according to claim 20, further comprising the step of detecting the scattered light from the object on the surface of the solid immersion lens.

22. The method according to any one of claims 20 to 21, further comprising the step of coating the surface of the solid immersion lens.

23. The method according to any one of claims 20 to 22, further comprising the step of cleaning the solid immersion lens.

24. The method according to claim 23, wherein the cleaning of the solid immersion lens includes flowing at least one cleaning solution through the fluid pathway.

25. The method according to claim 23 or 24, further comprising the step of agitating the cleaning solution.

26. The method according to any one of claims 20 to 25, further comprising the step of flowing air over the solid immersion lens.

27. The method according to any one of claims 20 to 26, further comprising the step of applying a plasma to the surface of the solid immersion lens.
